(19) United States
(12) Patent Application Publication
(10) Pub. No.: US 2024/0378976 A1
(43) Pub. Date: Nov. 14, 2024

(54) WORK SITE SAFETY-HAZARD NOTIFICATION SYSTEMS AND METHODS THEREOF

(71) Applicant: THE MARQUEE LTD., Medicine Hat (CA)

(72) Inventors: Rick Bitz, Medicine Hat (CA); Tracey Bitz, Medicine Hat (CA)

(21) Appl. No.: 18/660,571

(22) Filed: May 10, 2024

(30) Foreign Application Priority Data
May 10, 2023 (CA) 3199280

(51) Int. Cl. G08B 21/02; G08B 3/10; G08B 27/00

(52) U.S. Cl. CPC G08B 21/02; G08B 3/1016; G08B 27/00

(57) ABSTRACT

A safety-notification system for field workers to communicate safety hazards to equipment operators on a worksite, each field worker having a tool with a handle. The system has one or more signaling devices, each signaling device having a transmitter for wirelessly transmitting a targeted signal, and removeably attachable to the handle of the tool; one or more notification devices, each notification device having a receiver and a visual indicator. Each of the signaling devices is for associating with one or more of the notification devices, and each of the notification devices is for associating with one or more of the signaling devices. The receiver of each notification device is for receiving the targeted signal originating from the signaling device associated therewith and the visual indicator of each notification device is for notifying the equipment operator of the receipt of the targeted signal originating from the signaling device associated therewith.

### CROSS-REFERENCE TO RELATED APPLICATIONS

This application claims the benefit of Canadian Patent Application Serial No. 3,199,280, filed May 10, 2023, the content of which is incorporated herein by reference in its entirety.

### TECHNICAL FIELD

The present disclosure relates generally to safety-hazard notification systems for notifying equipment operators, and in particular, to safety-hazard notification systems where signaling devices are attachable to tools of field workers.

### BACKGROUND

On work sites in industries such as farming, road construction, mining, municipal planning, and sectors of the oil and gas industry, equipment operators use heavy machinery while field workers are located therearound. The heavy machinery is commonly loud and requires high levels of attention and focus of the equipment operators. In many instances, the equipment operators are commonly in an enclosed or semi-enclosed area such as the cab of an excavator, grader, dozer, or the like. Thus, the equipment operators may have very limited fields of vision to the surrounding area and it may be challenging for the equipment operator to visually assess the exterior surroundings on a consistent basis. The field workers, which may be referred to as helpers or swampers, working in the surrounding area on the ground may serve as a secondary source of observations of the surroundings to the equipment operator. The field workers are often the first to observe unusual or out of the ordinary circumstances, which may result in dangerous or catastrophic consequences. The difference between catastrophic consequences and a close call may depend on the ability of a field worker to effectively communicate the out of the ordinary circumstances to the equipment operator in a timely manner. Any delays and issues with clear communication may have significantly detrimental effects.

Currently in many of these work environments, workers may rely on yelling instructions to communicate potential issues. The environment proximate the machinery in question may not be the most amenable to hearing verbal communications from the workers due to a variety of factors such as machine noise, weather conditions, and other working crews operating nearby. As a result of these factors and the equipment operator being in an enclosed environment and potentially wearing ear protection, a worker yelling something like “stop” may become faintly heard if not completely missed.

Air horns are commonly used in such environments as a method of emergency notification. However, air horns are unreliable due to a number of factors including air horns being misplaced or frozen (in cold environments). Further, to operate an air horn, the worker must use a free hand. When the air horn is not being used, it is generally located on the body of the worker such as in a pocket of their coveralls. In the event the worker reaches for the air horn, they may need to drop their tool or other equipment to free a hand and, as a result, it may take some time for the worker to extract the air horn and operate it. Further, the use of an air horn may be confusing if there are multiple crews working in areas within ear shot.

### SUMMARY

The present disclosure provides systems and methods for field workers to notify equipment operators of safety hazards using signaling devices that may be installed on handles of tools for transmitting signals to notification devices that may be located within the enclosure of the machinery of equipment operators. The notification devices may provide visual and/or audible notification to the equipment operator. The systems and methods may also be capable of transmitting a broadcast site-wide shutdown signal to all notification devices within a geographical area.

By improving communications between field workers and equipment operators of potential safety hazards, potential of dangerous and catastrophic events may be reduced, which enhances safety, worker confidence and comfort, as well as reducing associated deaths, injuries, and other costs.

According to one aspect of this disclosure, there is provided a safety-notification system for field workers to communicate safety hazards to equipment operators on a worksite, each field worker having a tool with a handle, the system comprising: one or more signaling devices, each signaling device comprising a transmitter for wirelessly transmitting a targeted signal, and removeably attachable to the handle of the tool; one or more notification devices, each notification device comprising a receiver, and a visual indicator; each of the signaling devices is for associating with one or more of the notification devices, and each of the notification devices is for associating with one or more of the signaling devices; and the receiver of each notification device is for receiving the targeted signal originating from the signaling device associated therewith and the visual indicator of each notification device is for notifying the equipment operator of the receipt of the targeted signal originating from the signaling device associated therewith.

In some embodiments, each of the signaling devices comprises a first button for triggering the transmission of the targeted signal.

In some embodiments, each of the signaling devices is for transmitting a broadcast signal to all of the notification devices to indicate that a site-wide shutdown is occurring.

In some embodiments, the first button is for triggering the transmission of the broadcast signal when the first button is held down for a first hold length.

In some embodiments, each of the signaling devices comprises a second button for triggering the transmission of the broadcast signal.

In some embodiments, each of the notification devices comprises a touch screen.

In some embodiments, each of the notification devices comprises a speaker for producing an audible notification to the equipment operator upon receipt of the targeted signal originating from the signaling device associated therewith.

In some embodiments, the tool is a shovel.

In some embodiments, each of the signaling devices is weather resistant.

In some embodiments, the signaling devices and the notification devices communicate using radio frequency signals or BLUETOOTH®.

In some embodiments, each of the signaling devices is for pairing and unpairing to associate with one notification device at a time and each notification device is for pairing and unpairing to associate with one or more signaling devices at a time.

In some embodiments, each of the signaling devices comprises a button for pairing and unpairing to associate with a notification device.

In some embodiments, each of the notification devices comprises a logging unit to record information relating to targeted signals and broadcast signals.

In some embodiments, the system further comprises wireless chargers for charging the signaling devices.

According to one aspect of this disclosure, there is provided a method of notifying equipment operators of a safety hazard on a worksite by field workers, the method comprising the steps of: associating a signaling device of a field worker with a notification device of an equipment operator; transmitting a targeted signal from the signaling device; receiving the targeted signal at the notification device; and alerting the equipment operator visually of the receipt of the targeted signal.

In some embodiments, the method further comprises the steps of: transmitting a broadcast signal from the signaling device to indicate a site-wide shutdown is occurring; receiving the broadcast signal at the notification device; and alerting the equipment operator visually of the receipt of the broadcast signal.

In some embodiments, the method further comprises the step of associating a signaling device of another field worker with the notification device.

In some embodiments, the method further comprises the step of disassociating the signaling device with the notification device.

In some embodiments, the method further comprises the step of audibly alerting the equipment operator of the receipt of the targeted signal.

In some embodiments, the method further comprises the step of logging the occurrence of the targeted signal.

According to one aspect of this disclosure, there is provided a part for coupling to a handle of a hand tool, the part comprising: a transmitter; and a button functionally coupled to the transmitter for triggering the transmitter to wirelessly transmitting a signal directly to one or more notification devices for generating alarms thereon.

In some embodiments, the button is located adjacent a hand-grasp area of the handle.

### BRIEF DESCRIPTION OF THE DRAWINGS

For a more complete understanding of the disclosure, reference is made to the following description and accompanying drawings, in which:

FIG. 1 is a schematic of an embodiment of a safety notification system comprising signaling devices and notification devices, according to some embodiments of this disclosure;

FIG. 2 is a schematic diagram showing a simplified hardware structure of devices of the safety notification system shown in FIG. 1, according to some embodiments of this disclosure;

FIG. 3 is a schematic diagram showing a simplified software architecture of devices of the safety notification system shown in FIG. 1, according to some embodiments of this disclosure;

FIG. 4 is a block circuit diagram of an embodiment of a signaling device;

FIG. 5 is a block circuit diagram of an embodiment of a notification device;

FIG. 6A is a front view of an embodiment of a signaling device;

FIG. 6B is a side view of the signaling device of FIG. 6A;

FIG. 6C is a back view of the signaling device of FIG. 6A;

FIG. 6D is a top view of the signaling device of FIG. 6A;

FIG. 7A is a front view of an embodiment of a charging device;

FIG. 7B is a back view of the charging device of FIG. 7A;

FIG. 7C is a side view of the charging device of FIG. 7A;

FIG. 7D is a top view of the charging device of FIG. 7A;

FIG. 7E is a bottom view of the charging device of FIG. 7A;

FIG. 8A is a front view of an embodiment of a signaling device;

FIG. 8B is a side view of the signaling device of FIG. 8A;

FIG. 8C is a back view of the signaling device of FIG. 8A;

FIG. 8D is a isometric view of the signaling device of FIG. 8A;

FIG. 9A is a front view of the signaling device of FIG. 8A connected to the charging device of FIG. 7A;

FIG. 9B is a side view of the signaling device of FIG. 8A connected to the charging device of FIG. 7A;

FIG. 10 is a flowchart illustrating a method for notifying an equipment operator of a safety hazard;

FIG. 11A is a schematic diagram showing a hand tool in the form of a shovel having a signaling device on the handle thereof, according to some embodiments of this disclosure; and

FIG. 11B is a schematic diagram showing a hand tool in the form of a shovel having a signaling device on the handle thereof, according to some other embodiments of this disclosure.

### DETAILED DESCRIPTION

Unless otherwise defined, all technical and scientific terms used herein generally have the same meaning as commonly understood by one of ordinary skill in the art to which this disclosure pertains. Exemplary terms are defined below for ease in understanding the subject matter of the present disclosure.

The term “a” or “an” refers to one or more of that entity; for example, “a terminal” refers to one or more terminals or at least one terminal. As such, the terms “a” (or “an”), “one or more” and “at least one” are used interchangeably herein. In addition, reference to an element or feature by the indefinite article “a” or “an” does not exclude the possibility that more than one of the elements or features are present, unless the context clearly requires that there is one and only one of the elements. Furthermore, reference to a feature in the plurality (e.g., systems), unless clearly intended, does not mean that the systems or methods disclosed herein must comprise a plurality.

The expression “and/or” refers to and encompasses any and all possible combinations of one or more of the associated listed items (e.g. one or the other, or both), as well as the lack of combinations when interrupted in the alternative (or).

In some embodiments of the present disclosure, systems and methods provide effective, timely and targeted communication of potential safety hazards from field workers to equipment operators. The equipment operators may be located within enclosed or semi-enclosed areas, such as a cab of a piece of machinery, which presents challenges to the ability of the equipment operator to visually and/or audibly assess situational circumstances and/or communications from the field workers. Additionally, components of systems provided herein may further improve timeliness and quality of communication through their integration to both the typical environments of field workers and equipment operators.

In some embodiments, a system is provided comprising notification devices for communicating to equipment operators and signaling devices attached to tools commonly used by field workers, such as shovels, permitting the field workers to communication potential safety hazards to the equipment operators with visual and audible alarms, the communication readily triggered by pressing buttons located on tools which may already in the hands of the field workers.

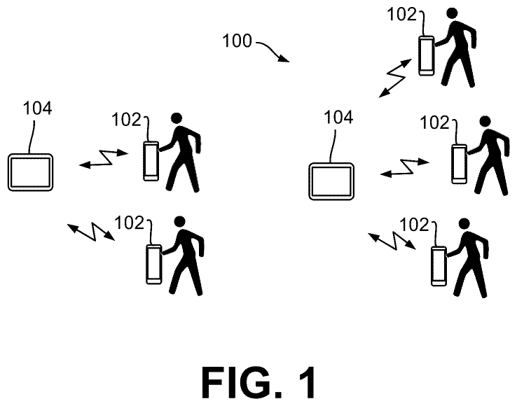

FIG. 1 illustrates system 100 according to some embodiments disclosed herein. The system 100 comprises one or more signaling devices 102 and one or more notification devices 104. Each of the signaling devices 102 is generally intended to be associated with one field worker and each notification device 104 is generally intended to be associated with one piece of machinery. The signaling devices 102 are generally for transmitting a targeted signal to one or more of the notification devices 104 with each signaling device 102 is being associated with one or more particular notification devices 104 at any given time. This corresponds to a work site environment wherein one or more field workers are working in proximity to one or more specific pieces of machinery. The signaling devices 102 may also have feature to transmit a broadcast signal intended for all notification devices within the communication range thereof, whether associated therewith or not, to indicate a site-wide shutdown is occurring. In this instances, the notification devices 104 may be configured to receive such signals from any signaling device 102.

Each signaling device 102 may be attachable to the handle of a tool of a field worker. The signaling devices 102 may be attachable to the end of a handle of a tool to permit quick access and provide suitable positioning for transmission. The tool in question may be a shovel, a rake, a hoe, a pick, and/or the like. The tool and/or any portion thereof, such as the handle, may comprise any material having suitable durability and other features, such as non-conductivity. For example, the material may be plastic, carbon, wood, or aluminum. Each signaling device 102 may be attachable to the handle of a tool using any appropriate attachment mechanism including using friction fit, interference fit, clipping, locking, clamping, screwing, bolting, adhesion, and/or the like.

Depending on the intended application, the signaling devices 102 may be made to be either weather resistant or weather proof as is suitable. To initiate the transmission of a signal from the signaling devices 102, the signaling devices 102 may comprise one or more buttons. For example, the signaling devices 102 may comprise three or more buttons or trigger mechanisms, where one is for transmitting a targeted signal, one is for transmitting a broadcast signal, and one is for pairing and/or configuration with a notification device 104. In some other embodiments, the signaling devices 102 may comprise a signal button or trigger mechanism, wherein different sequence patterns or durations of pressing the button may result in the signaling device 102 transmitting a particular type of signal or for pairing/configuration. For example, a press and immediate release may result in the transmission of a targeted signal, a press and hold for a first hold length or period, such as five seconds, may result in the transmission of a broadcast signal, and a press and hold for a second, longer period, such as 20 seconds, may result in the signaling device 102 entering a pairing and/or configuration mode. The one or more buttons may have a required resistance to activate. For example, a specific amount of pressure may be required to activate a button to prevent accidental or unintentional activation. Alternatively, the one or more buttons may have a required travel distance to activate. For example, a button must be pressed a specific distance to activate a button to prevent accidental or unintentional activation.

The notification device 104 provides a visual and/or an audible indication of the receipt of one or more of a targeted signal or a broadcast signal. The notification device 104 may comprise one or more lights such as one or more light emitting diodes (LEDs), and/or a speaker. In some embodiments, the notification device 104 may comprise a screen to provide a user interface, which may be a touch screen. Alternatively, the notification device 104 may comprise one or more buttons and/or be configured by another device such as a computer, a laptop, a remote, a smartphone, and/or the like.

In some embodiments, each signaling device 102 may generally be associated with a particular notification device 104. In contrast, each notification device 104 may generally be associated with a plurality of signaling device 102. This is to reflect an N to 1 relationship between workers to equipment. In some other embodiments, a work site may comprise two or more pieces of machinery generally in proximity to a common group of field workers. In such a case, the signaling devices 102 may be associated with more than one notification device 104 at a time. There are no limitations on how many number of either signaling devices 102 or notification devices 104 may be included in a system but depending on the implementation, technological limitations may exist. In applications where the communication protocol supports it, the signaling devices 102 and notification devices 104 may be paired and unpaired as appropriate to make the desired associations.

The notification devices 104 may comprise a logging unit, which tracks information relating to targeted signals and broadcast signals. This information may include times, dates, the signaling devices 102 associated with the notification device 104, the number of times an alarm was activated, and the time required to completely shutdown after an alarm was signaled. The notification devices 104 may comprise a clock, which can be manually and/or automatically set, for ensuring the logged times and dates are accurate. The clock may be automatically set by interfacing with a GPS module, atomic radio signal module, and/or extracting time and date information from cellular and/or wireless network signals. The clock may also be automatically set using an interface with any computer or electronic device that can either communicate with the notification device 104 wirelessly or hard-wired.

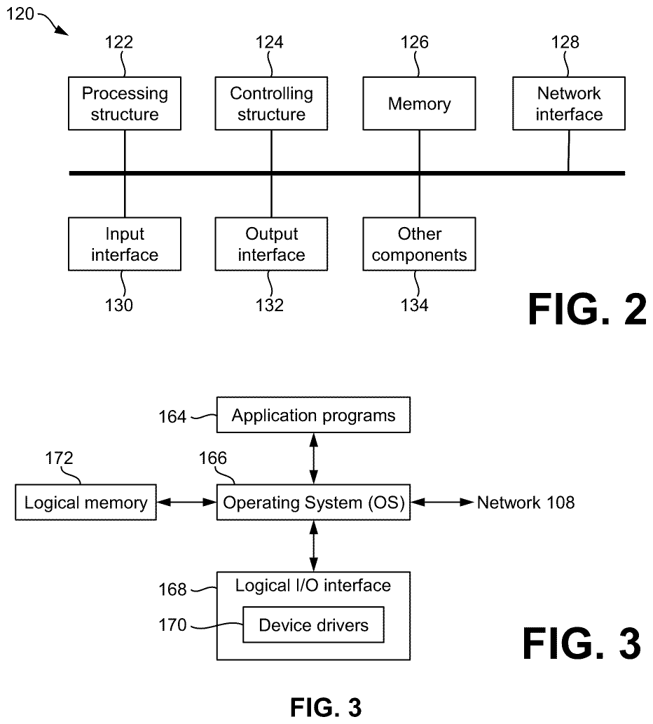

Generally, the signaling device 102 and the notification device 104 may comprise similar hardware structures such as hardware structure 120 shown in FIG. 2. As shown, the hardware structure 120 comprises a processing structure 122, a controlling structure 124, one or more non-transitory computer-readable memory or storage devices 126, a communication interface 128, an input interface 130, and an output interface 132, functionally interconnected by a system bus 138. The hardware structure 120 may also comprise other components 134 coupled to the system bus 138.

The processing structure 122 may be one or more single-core or multiple-core computing processors, generally referred to as central processing units (CPUs), such as INTEL® microprocessors (INTEL is a registered trademark of Intel Corp., Santa Clara, CA, USA), AMD® microprocessors (AMD is a registered trademark of Advanced Micro Devices Inc., Sunnyvale, CA, USA), ARM® microprocessors (ARM is a registered trademark of Arm Ltd., Cambridge, UK) manufactured by a variety of manufactures such as Qualcomm of San Diego, California, USA, under the ARM® architecture, or the like. When the processing structure 122 comprises a plurality of processors, the processors thereof may collaborate via a specialized circuit such as a specialized bus or via the system bus 138.

The processing structure 122 may also comprise one or more real-time processors, programmable logic controllers (PLCs), microcontroller units (MCUs), u-controllers (UCs), specialized/customized processors, hardware accelerators, and/or controlling circuits (also denoted “controllers”) using, for example, field-programmable gate array (FPGA) or application-specific integrated circuit (ASIC) technologies, and/or the like. In some embodiments, the processing structure includes a CPU (otherwise referred to as a host processor) and a specialized hardware accelerator.

For example, the processing structure 122 may comprise logic gates implemented by semiconductors to perform various computations, calculations, and/or processings. Examples of logic gates include AND gate, OR gate, XOR (exclusive OR) gate, and NOT gate, each of which takes one or more inputs and generates or otherwise produces an output therefrom based on the logic implemented therein. For example, a NOT gate receives an input (for example, a high voltage, a state with electrical current, a state with an emitted light, or the like), inverts the input (for example, forming a low voltage, a state with no electrical current, a state with no light, or the like), and output the inverted input as the output.

While the inputs and outputs of the logic gates are generally physical signals and the logics or processings thereof are tangible operations with physical results (for example, outputs of physical signals), the inputs and outputs thereof are generally described using numerals (for example, numerals “0” and “1”) and the operations thereof are generally described as “computing” (which is how the “computer” or “computing device” is named) or “calculation”, or more generally, “processing”, for generating or producing the outputs from the inputs thereof.

Sophisticated combinations of logic gates in the form of a circuitry of logic gates, such as the processing structure 122, may be formed using a plurality of AND, OR, XOR, and/or NOT gates. Such combinations of logic gates may be implemented using individual semiconductors, or more often be implemented as integrated circuits (ICs).

A circuitry of logic gates may be “hard-wired” circuitry which, once designed, may only perform the designed functions. In this example, the processes and functions thereof are “hard-coded” in the circuitry.

With the advance of technologies, it is often that a circuitry of logic gates such as the processing structure 122 may be alternatively designed in a general manner so that it may perform various processes and functions according to a set of “programmed” instructions implemented as firmware and/or software and stored in one or more non-transitory computer-readable storage devices or media. In this example, the circuitry of logic gates such as the processing structure 122 is usually of no use without meaningful firmware and/or software.

Of course, those skilled the art will appreciate that a process or a function (and thus the processor 102) may be implemented using other technologies such as analog technologies.

Referring back to FIG. 2, the controlling structure 124 comprises one or more controlling circuits, such as graphic controllers, input/output chipsets and the like, for coordinating operations of various hardware components and modules of the signaling device 102 and/or the notification device 104.

The memory 126 comprises one or more storage devices or media accessible by the processing structure 122 and the controlling structure 124 for reading and/or storing instructions for the processing structure 122 to execute, and for reading and/or storing data, including input data and data generated by the processing structure 122 and the controlling structure 124. The memory 126 may be volatile and/or non-volatile, non-removable or removable memory such as RAM, ROM, EEPROM, solid-state memory, hard disks, CD, DVD, flash memory, or the like.

The communication interface 128 comprises one or more communication modules for connecting to other devices using suitable wireless communication technologies such as WI-FI® (WI-FI is a registered trademark of Wi-Fi Alliance, Austin, TX, USA), BLUETOOTH® (BLUETOOTH® is a registered trademark of Bluetooth Sig Inc., Kirkland, WA, USA), Bluetooth Low Energy (BLE), Z-Wave, Long Range (LoRa), ZIGBEE® (ZIGBEE is a registered trademark of ZigBee Alliance Corp., San Ramon, CA, USA), wireless broadband communication technologies such as Global System for Mobile Communications (GSM), Code Division Multiple Access (CDMA), Universal Mobile Telecommunications System (UMTS), Worldwide Interoperability for Microwave Access (WiMAX), CDMA2000, Long Term Evolution (LTE), 3GPP, 5G New Radio (5G NR) and/or other 5G networks, and/or the like.

The input interface 130 comprises one or more input modules for one or more users to input data via, for example, touch-sensitive screen, touch-pad, keyboards, computer mouse, trackball, and/or the like. The input interface 130 may be a physically integrated part of the notification device 104 (for example, the touch-pad of a laptop computer or the touch-sensitive screen of a tablet), or may be a device physically separate from, but functionally coupled to, other components of the notification device 104 (for example, a computer mouse). The input interface 130, in some implementation, may be integrated with a display output to form a touch-sensitive screen.

The output interface 132 comprises one or more output modules for output data to a user. Examples of the output modules comprise displays (such as monitors, LCD displays, LED displays, projectors, and the like), speakers, and/or the like. The output interface 132 may be a physically integrated part of the notification device 104 (for example, the display of a laptop computer or tablet), or may be a device physically separate from but functionally coupled to other components of the notification device 104 (for example, the monitor of a desktop computer).

The system bus 138 interconnects various components 122 to 134 enabling them to transmit and receive data and control signals to and from each other.

FIG. 3 shows a simplified software architecture 160 of the notification device 104. The software architecture 160 comprises one or more application programs 164, an operating system 166, a logical input/output (I/O) interface 168, and a logical memory 172. The one or more application programs 164, operating system 166, and logical I/O interface 168 are generally implemented as computer-executable instructions or code in the form of software programs or firmware programs stored in the logical memory 172 which may be executed by the processing structure 122.

The one or more application programs 164 executed by or run by the processing structure 122 for performing various tasks.

The operating system 166 manages various hardware components of the computing device 102 or 104 via the logical I/O interface 168, manages the logical memory 172, and manages and supports the application programs 164. The operating system 166 is also in communication with other computing devices (not shown) via the network 108 to allow application programs 164 to communicate with those running on other computing devices. As those skilled in the art will appreciate, the operating system 166 may be any suitable operating system such as MICROSOFT® WINDOWS® (MICROSOFT and WINDOWS are registered trademarks of the Microsoft Corp., Redmond, WA, USA), APPLE® OS X, APPLE® IOS (APPLE is a registered trademark of Apple Inc., Cupertino, CA, USA), Linux, ANDROID® (ANDROID is a registered trademark of Google LLC, Mountain View, CA, USA), or the like.

The logical I/O interface 168 comprises one or more device drivers 170 for communicating with respective input and output interfaces 130 and 132 for receiving data therefrom and sending data thereto. Received data may be sent to the one or more application programs 164 for being processed by one or more application programs 164. Data generated by the application programs 164 may be sent to the logical I/O interface 168 for outputting to various output devices (via the output interface 132).

The logical memory 172 is a logical mapping of the physical memory 126 for facilitating the application programs 164 to access. In this embodiment, the logical memory 172 comprises a storage memory area that may be mapped to a non-volatile physical memory such as hard disks, solid-state disks, flash drives, and the like, generally for long-term data storage therein. The logical memory 172 also comprises a working memory area that is generally mapped to high-speed, and in some implementations volatile, physical memory such as RAM, generally for application programs 164 to temporarily store data during program execution. For example, an application program 164 may load data from the storage memory area into the working memory area, and may store data generated during its execution into the working memory area. The application program 164 may also store some data into the storage memory area as required or in response to a user's command.

As described above, the processing structure 122 is usually of no use without meaningful firmware and/or software. Similarly, while a system such as the system 100 may have the potential to perform various tasks, it cannot perform any tasks and is of no use without meaningful firmware and/or software. As will be described in more detail later, the system 100 described herein and the modules, circuitries, and components thereof, as a combination of hardware and software, generally produces tangible results tied to the physical world, wherein the tangible results such as those described herein may lead to improvements to the computer devices and systems themselves, the modules, circuitries, and components thereof, and/or the like.

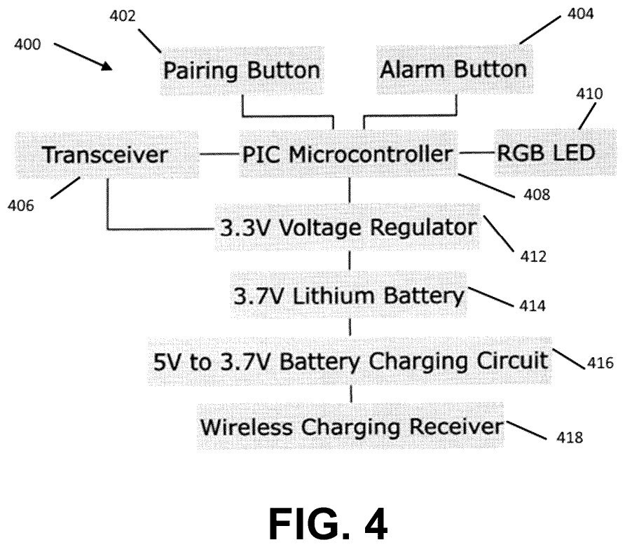

While the above discussion applies generally, in some embodiments, a more specific structure of the signaling devices 102 is used, such as that shown in FIG. 4. Referring to FIG. 4, an exemplary embodiment of a signaling device circuit 400 comprises a programmable interface controller (PIC) microcontroller 408 connected to and for managing a transceiver module 406, a pairing button 402, an alarm button 404, an red green blue (RGB) LED 408 and some power components. The transceiver module 406 is for communicating with the notification device 104. The pairing button 402 is for initiating association, or pairing and unpairing, between the signaling device 102 and the notification device 104. The alarm button 404 is for sending the targeted signal and/or the broadcast signal and the RGB LED 408 is used to indicate various statuses of the signaling device 102 to a user. The power components comprise a 3.3 volt (V) voltage regulator 412, a 3.7V lithium battery 414, a 5V to 3.7V battery charging circuit 416, and a wireless charging receiver 418. In some embodiments disclosed herein, the signaling devices 102 may be wirelessly charged.

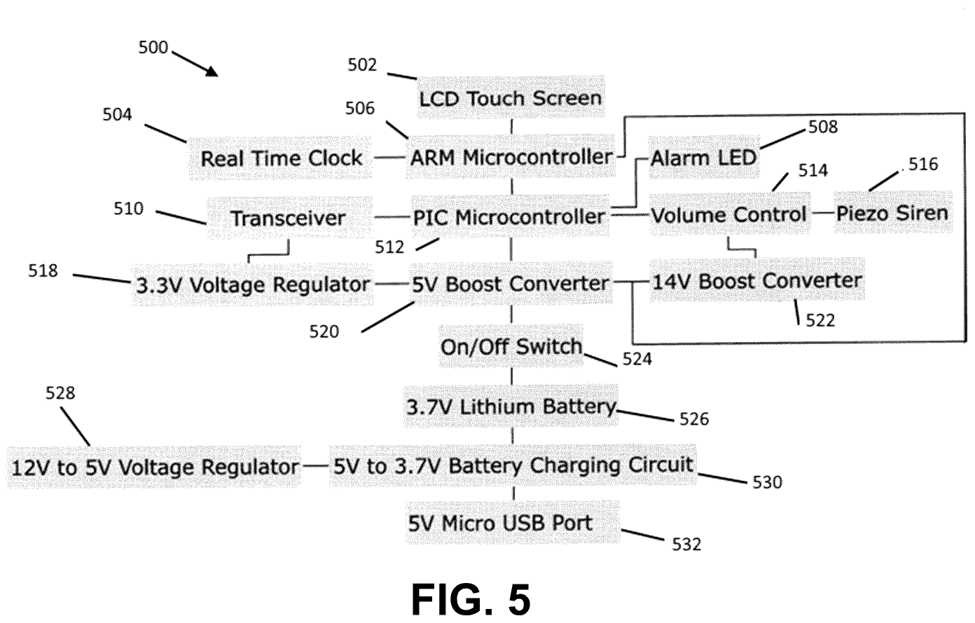

FIG. 5 similarly illustrates an exemplary embodiment of the notification device 104 having a more specific structure. An exemplary embodiment of a notification device circuit 500 comprises a PIC microcontroller 512 connected to and for managing a transceiver module 510, an alarm LED 508, a volume control module 514 and power components. The transceiver module 510 is for communicating with signaling devices 102. The alarm LED 508 for indicating conditions of the notification device 104. The volume control module 514 connected to power components and a piezoelectric siren 516 for producing an audible alarm. The PIC microcontroller 512 may also be connected to an ARM® microcontroller 506, which in turn is connected to a real time clock 504 and an LCD touch screen 502, the ARM® microcontroller for interfacing with the PIC microcontroller 512 and controlling the LCD touch screen 502. The power components comprise a 3.3V voltage regulator 518, a 5V boost converter 520, a 14V boost converter 522, and on/off switch 524, a 3.7V lithium battery 526, a 12V to 5V voltage regulator 528, a 5V to 3.7V battery charging circuit 530 and a 5V micro USB port 532. The LCD touch screen 502 may comprise a standalone power source, such as a battery or may be connected to the power system of the notification device circuit 500 comprising the 3.7V lithium battery 526 charged by the 5V to 3.7V battery charging circuit 530 through the 5V micro USB port.

A person of skill would understand that each of the structures of FIG. 4 and FIG. 5 may on one or more customized circuit boards, motherboards, and/or the like. Alternatively, any the structures or any portion thereof may include discrete components interconnected as appropriate.

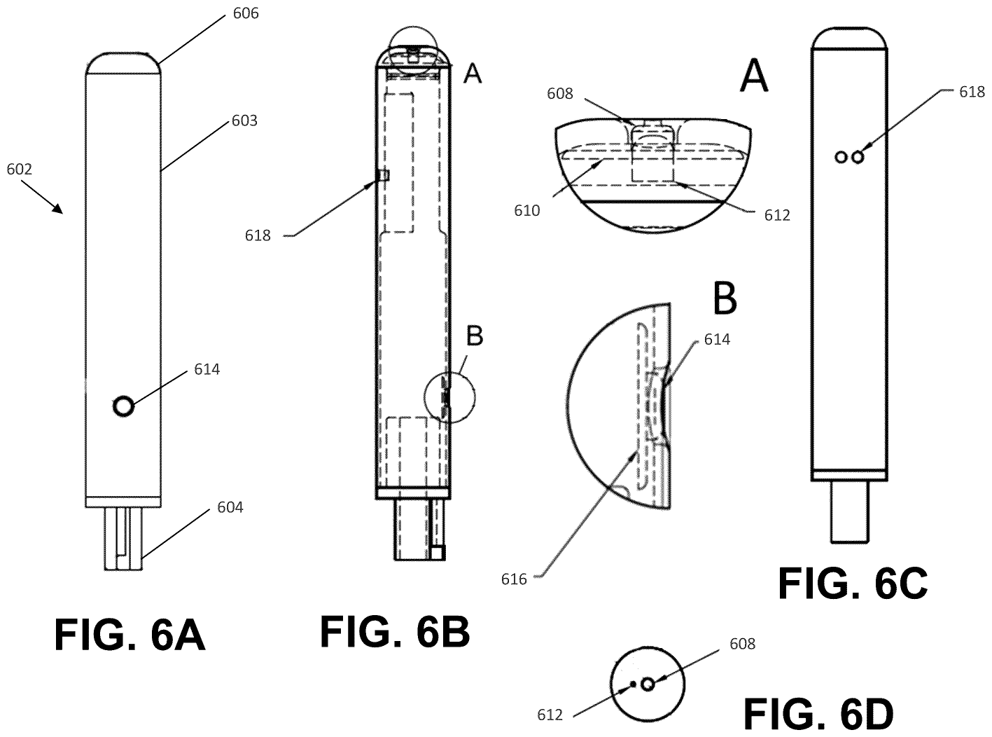

FIGS. 6A to 6D show an embodiment of signaling device 602 illustrating the locations of some physical features thereof. The signaling device 602 is in the form of a part for coupling to the handle of a hand tool such as a shovel, and comprises a housing 603 comprising an attachment end 604, which is generally for attaching to a tool handle, and an end cap 606 attached to the housing 603 and located distal the attachment end 604. The end cap 606 comprising a pairing button 608, a pairing-button weather seal 610, and an pairing LED 612 as shown in detail “A” of FIG. 6B. The pairing button 608 may be recessed within the end cap 604 and the pairing-button weather seal is for preventing moisture and debris from entering the interior of the signaling device 602. The pairing LED 612 is to indicate pairing status to a user. The signaling device 602 may also comprise an alarm button 614 and an alarm-button weather seal 616 as shown in detail “B” of FIG. 6B. The alarm button 614 may be similarly recessed within the body of the housing 603 and the alarm-button weather seal 616 is for preventing moisture and debris from entering the interior of the signaling device 602. The housing 603 may further comprise a pair of charging contact 618 for charging the signaling device 602.

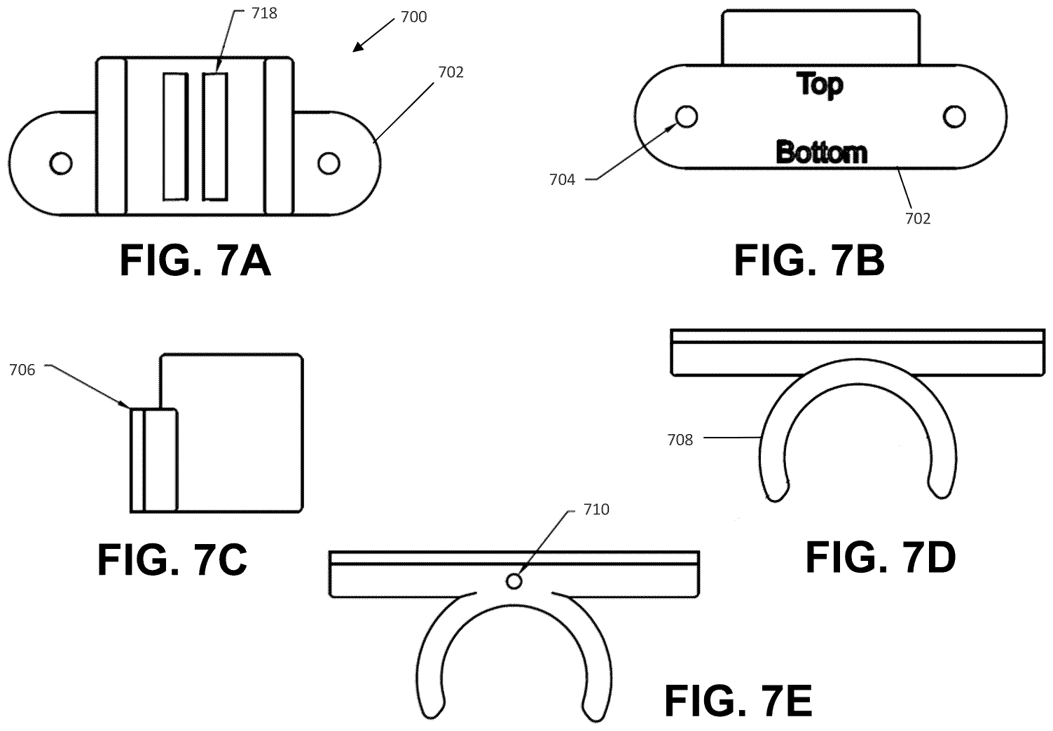

FIGS. 7A to 7E illustrate an exemplary embodiment of a charging device 700. The charging device 700 may comprise a planar member 702. The planar member 702 may comprise two or more mounting holes 704 for the mounting the charging device 700 to a wall. The planar member 702 may also house an electronic charging circuitry, which may be covered by a charging circuit cover plate 706. The charging device 700 further comprises a retention bracket 708, which may be semi-circular to matingly retain a housing of the signaling device 602. The charging device 700 may further comprise a charging cable inlet 710 for receiving power from an external power source and two or more charging contacts 718 for charging a signaling device.

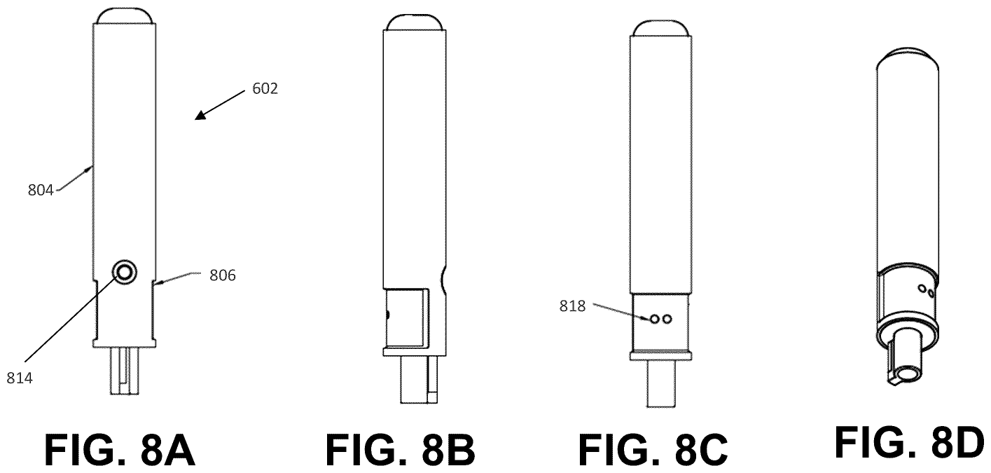

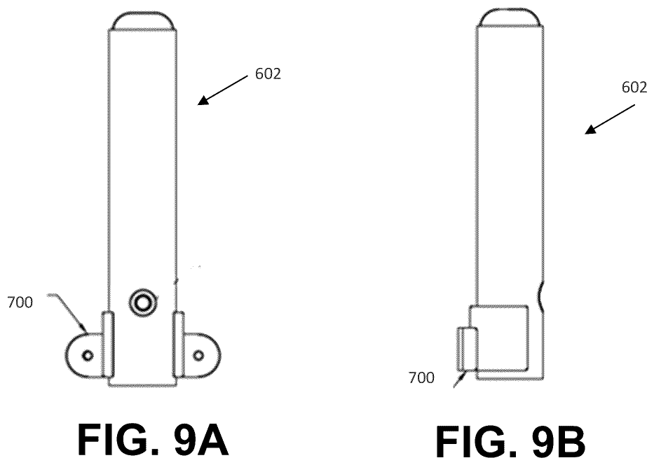

FIGS. 8A to 8D illustrate an exemplary embodiment of a signaling device 602 with features for use with the charging device 700 of FIGS. 7A to 7E. FIGS. 9A and 9B show the signaling device 602 mounted in the charging device 700. Referring to FIG. 8A, the signaling device 602 comprises an outer sleeve 804, the outer sleeve 804 comprising a sleeve cutout 814 for access to the alarm button and a sleeve notch 806 to align with the charging device 700. The signaling device 602 comprises charging contacts 818 in the sleeve notch 806 located to correspond with the interface with the electrical contacts 718 of the charging device 700. The outer sleeve 804 may comprise plastic, rubber, and/or any other suitable material. The sleeve notch 806 may have a snap fit with the retention bracket 708 and the use of a notch prevents the signaling device 602 from axial movement when attached to the charging device 700 in this manner.

Some embodiments of the signaling devices and components thereof described herein are attachable, meaning they are intended to be removeably attached to or coupled to another device or component, allowing them to be interchangeably used between hand tools such as shovels, and may be designed to be waterproof, safe, wireless rechargeable and use communication protocols and signals that do not cause interference with other signals at work site. The systems disclosed herein may be used in a wide variety of applications such as farming, road construction, mining, municipal planning, and sectors of the oil and gas industry.

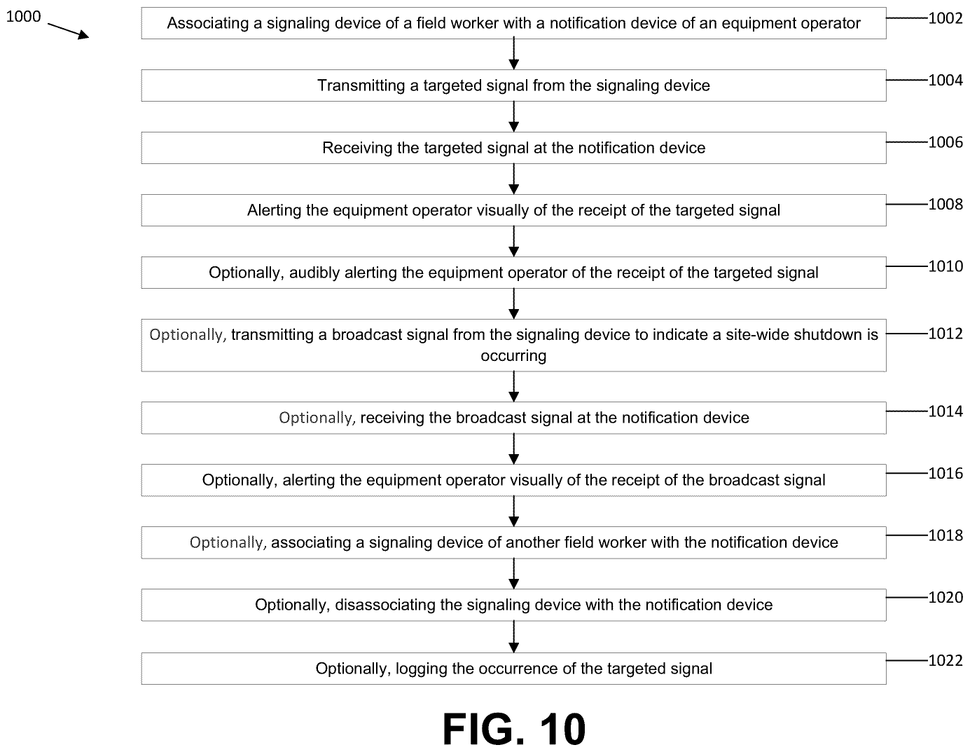

FIG. 10 is a flowchart showing the steps of a method 1000, according to one embodiment of the present disclosure. The method 1000 begins with associating a signaling device of a field worker with a notification device of an equipment operator (step 1002). At step 1004, a targeted signal is transmitted from the signaling device. At step 1006, the targeted signal is received at the notification device. At step 1008, the equipment operator is visually alerted of the receipt of the targeted signal. Optionally, at step 1010, the equipment operator is audibly alerted of the receipt of the targeted signal. Optionally, at step 1012, a broadcast signal from the signaling device is transmitted to indicate a site-wide shutdown is occurring. Optionally, at step 1014, the broadcast signal is received at the notification device. Optionally, at step 1016 the equipment operator is visually alerted of the receipt of the broadcast signal. Optionally, at step 1018, the signaling device of another field worker is associated with the notification device. Optionally, at step 1020, the signaling device is dissociated with the notification device. Optionally, at step 1022, the occurrence of the targeted signal is logged.

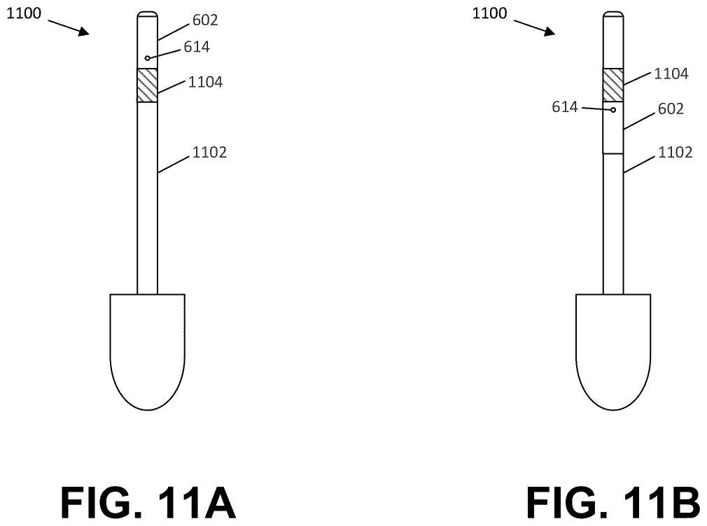

FIG. 11A is a schematic diagram showing a hand tool 1100 in the form of a shovel. The shovel 1100 comprises a handle 1102 having at least one hand-grasp area 1104 for a user to put a hand in the hand-grasp area 1104 for holding the shovel 1100. In these embodiments, the shovel 1100 comprises a signaling device 602 as an end piece of the handle 1102 adjacent the hand-grasp area 1104. More specifically, the alarm button 614 of the signaling device 602 is adjacent the hand-grasp area 1104 such that the user, when in an emergency situation, may quickly and easily press the alarm button to trigger an alarm as described above.

FIG. 11B is a schematic diagram showing a hand tool 1100 in the form of a shovel. The shovel 1100 is similar to that shown in FIG. 11A except that the signaling device 602 is sandwiched between an end piece 1106 and the handle 1102. The end piece 1106 comprises a hand-grasp area 1104 for a user to put a hand in the hand-grasp area 1104 for holding the shovel 1100. In these embodiments, the signaling device 602 and more specifically the alarm button 614 thereof is adjacent the hand-grasp area 1104 such that the user, when in an emergency situation, may quickly and easily press the alarm button to trigger an alarm as described above.

In some embodiments, the transceiver module 406 shown in FIG. 4 may be a transmitter module, and the transceiver module 510 shown in FIG. 5 may be a receiver module.

In the embodiment shown in FIGS. 6A to 6C, the signaling device 602 is a separate part for coupling to the handle of a hand tool. In some other embodiments, the signaling device 602 may be an integrated part of the handle of the hand tool.

Although embodiments have been described above with reference to the accompanying drawings, those of skill in the art will appreciate that variations and modifications may be made without departing from the scope thereof as defined by the appended claims.

What is claimed is:

1. A safety-notification system for field workers to communicate safety hazards to equipment operators on a worksite, each field worker having a tool with a handle, the system comprising:
one or more signaling devices, each signaling device
comprising a transmitter for wirelessly transmitting a targeted signal, and
removeably attachable to the handle of the tool;
one or more notification devices, each notification device comprising
a receiver, and
a visual indicator;
wherein each of the signaling devices is for associating with one or more of the notification devices, and each of the notification devices is for associating with one or more of the signaling devices; and
wherein the receiver of each notification device is for receiving the targeted signal originating from the signaling device associated therewith and the visual indicator of each notification device is for notifying the equipment operator of the receipt of the targeted signal originating from the signaling device associated therewith.

2. The system of claim 1, wherein each of the signaling devices comprises a first button for triggering the transmission of the targeted signal.

3. The system of claim 1, wherein each of the signaling devices is for transmitting a broadcast signal to all of the notification devices to indicate that a site-wide shutdown is occurring.

4. The system of claim 3, wherein the first button is for triggering the transmission of the broadcast signal when the first button is held down for a first hold length.

5. The system of claim 3, wherein each of the signaling devices comprises a second button for triggering the transmission of the broadcast signal.

6. The system of claim 1, wherein each of the notification devices comprises a touch screen.

7. The system of claim 1, wherein each of the notification devices comprises a speaker for producing an audible notification to the equipment operator upon receipt of the targeted signal originating from the signaling device associated therewith.

8. The system of claim 1, wherein the tool is a shovel.

9. The system of claim 1, wherein each of the signaling devices is weather resistant.

10. The system of claim 1, wherein the signaling devices and the notification devices communicate using radio frequency signals or BLUETOOTH®.

11. The system of claim 1, wherein each of the signaling devices is for pairing and unpairing to associate with one notification device at a time and each notification device is for pairing and unpairing to associate with one or more signaling devices at a time.

12. The system of claim 11, wherein each of the signaling devices comprises a button for pairing and unpairing to associate with a notification device.

13. The system of claim 1, wherein each of the notification devices comprises a logging unit to record information relating to targeted signals and broadcast signals.

14. A method of notifying equipment operators of a safety hazard on a worksite by field workers, the method comprising the steps of:
associating a signaling device of a field worker with a notification device of an equipment operator;
transmitting a targeted signal from the signaling device;
receiving the targeted signal at the notification device; and
alerting the equipment operator visually of the receipt of the targeted signal.

15. The method of claim 14 further comprising the steps of:
transmitting a broadcast signal from the signaling device to indicate a site-wide shutdown is occurring;
receiving the broadcast signal at the notification device; and
alerting the equipment operator visually of the receipt of the broadcast signal.

16. The method of claim 14 further comprising the step of associating a signaling device of another field worker with the notification device.

17. The method of claim 14, further comprising the step of audibly alerting the equipment operator of the receipt of the targeted signal.

18. The method of claim 14, further comprising the step of logging the occurrence of the targeted signal.

19. A part for coupling to a handle of a hand tool, the part comprising:
a transmitter; and
a button functionally coupled to the transmitter for triggering the transmitter to wirelessly transmitting a signal directly to one or more notification devices for generating alarms thereon.

20. The part of claim 19, wherein the button is located adjacent a hand-grasp area of the handle.
